(19) United States
(12) Patent Application Publication
(10) Pub. No.: US 2013/0324057 A1
(43) Pub. Date: Dec. 5, 2013

(54) DETERMINING A DELIVERED POWER ESTIMATE AND A LOAD IMPEDANCE ESTIMATE USING A DIRECTIONAL COUPLER

(71) Applicants: Xiangdong Zhang, Westford, MA (US); Xinwei Wang, Boxborough, MA (US); Puay Hoe See, San Diego, CA (US)

(72) Inventors: Xiangdong Zhang, Westford, MA (US); Xinwei Wang, Boxborough, MA (US); Puay Hoe See, San Diego, CA (US)

(73) Assignee: QUALCOMM Incorporated, San Diego, CA (US)

(21) Appl. No.: 13/619,061

(22) Filed: Sep. 14, 2012

Related U.S. Application Data
(60) Provisional application No. 61/654,035, filed on May 31, 2012.

(51) Int. Cl. H04B 1/40

(52) U.S. Cl. CPC H04B 1/40
USPC 455/77

(57) ABSTRACT

A wireless device configured for optimizing a delivered power is described. The wireless device includes a filter duplexer or switch coupled to a transmitter and a receiver. The wireless device also includes a power/impedance detector coupled to the filter duplexer or switch. The power/impedance detector includes a directional coupler. An antenna is coupled to the power/impedance detector. Other aspects, embodiments and features are also claimed and described.

### RELATED APPLICATION AND PRIORITY CLAIM

This application is related to and claims priority to U.S. Provisional Patent Application Ser. No. 61/654,035, filed May 31, 2012, for “DETERMINING A DELIVERED POWER ESTIMATE AND A LOAD IMPEDANCE ESTIMATE USING A DIRECTIONAL COUPLER,” which is incorporated herein by reference for all purposes and as if fully set forth below.

### TECHNICAL FIELD

Embodiments of the present invention relate generally to wireless communication systems. More specifically, embodiments of the present invention relate to systems and methods for determining a delivered power estimate and a load impedance estimate using a directional coupler.

### BACKGROUND

Wireless communications systems are widely deployed to provide various types of communication content such as voice, video, data and so on. A wireless communication system may provide communication for a number of subscriber stations, each of which may be serviced by one or more base stations.

Subscriber stations and base stations may communicate wirelessly. Thus, subscriber stations and base stations may use antennas to transmit signals. The performance of these antennas may suffer from radiation condition variations or a broad frequency range. Thus, an antenna may not function exactly as intended, reducing the efficiency of transmissions. Benefits may be realized by improved systems and methods for determining performance losses within an antenna and making adjustments to compensate for those losses.

### BRIEF DESCRIPTION OF THE DRAWINGS

FIG. 1 shows an example of a wireless device in which embodiments of the present invention disclosed herein may be utilized;

FIG. 2 is a flow diagram of a method for determining a delivered power TRP estimate and a load impedance Zload estimate using a directional coupler according to some embodiments of the present invention;

FIG. 3 is a block diagram of a power/impedance detector according to some embodiments of the present invention;

FIG. 4 is a flow diagram of another method for determining a delivered power TRP estimate and a load impedance Zload estimate using a directional coupler;

FIG. 5 is a block diagram of another power/impedance detector according to some embodiments of the present invention;

FIG. 6 is a flow diagram of a method for determining a delivered power TRP estimate and a load impedance Zload estimate using a directional coupler and a first impedance Zj;

FIG. 7 is a block diagram of yet another power/impedance detector according to some embodiments of the present invention;

FIG. 8 is a flow diagram of a method for determining a delivered power TRP estimate and a load impedance Zload estimate using a directional coupler, a first impedance and a second impedance;

FIG. 9 illustrates certain components that may be included within a base station according to some embodiments of the present invention; and

FIG. 10 illustrates certain components that may be included within a wireless device according to some embodiments of the present invention.

### SUMMARY OF SOME EXAMPLE EMBODIMENTS

A wireless device configured for optimizing a delivered power is described. The wireless device includes a filter duplexer or switch coupled to a transmitter and a receiver. The wireless device also includes a power/impedance detector coupled to the filter duplexer or switch, wherein the power/impedance detector comprises a directional coupler. The wireless device also includes an antenna coupled to the power/impedance detector.

The power/impedance detector may include a plurality of voltage detection circuits. The plurality of voltage detection circuits may measure a plurality of voltages within the power/impedance detector. The plurality of voltage detection circuits may be root means squared (RMS) voltage detection circuits. The power/impedance detector may be configured to determine a delivered power estimate based on the plurality of voltages. The power/impedance detector may also be configured to determine a load impedance estimate based on the plurality of voltages.

The wireless device may include a tuner control. The tuner control may be configured to determine tuning parameters for an impedance matching circuit based on the delivered power estimate and the load impedance estimate. The tuner control may apply the tuning parameters to the impedance matching circuit to optimize the delivered power.

The power/impedance detector may include a first voltage detection circuit, a second voltage detection circuit, a third voltage detection circuit and a fourth voltage detection circuit. The voltage detection circuits may measure a plurality of voltages within the power/impedance detector. The directional coupler may also include a first port, a second port, a third port and a fourth port.

The first voltage detection circuit may be coupled to the third port. The second voltage detection circuit may be coupled to the fourth port. The third voltage detection circuit may be coupled to the second port. The fourth voltage detection circuit may be coupled to the first port.

The wireless device may also include a first impedance coupled between the second port and the antenna. The first voltage detection circuit may be coupled to the third port. The second voltage detection circuit may be coupled to the fourth port. The third voltage detection circuit may be coupled to the second port. The fourth detection circuit may be coupled between the first impedance and the antenna.

The wireless device may also include a fifth voltage detection circuit. The wireless device may also include a first impedance coupled to the second port. The wireless device may also include a second impedance coupled between the first impedance and the antenna. The first voltage detection circuit may be coupled to the third port. The second voltage detection circuit may be coupled to the fourth port. The third voltage detection circuit may be coupled to the second port. The fourth voltage detection circuit may be coupled between the first impedance and the second impedance. The fifth voltage detection circuit may be coupled between the second impedance and the antenna.

The power/impedance detector may also be configured to monitor a plurality of voltages. The power/impedance detector may also determine a delivered power estimate based on the plurality of voltages within time intervals. The power/impedance detector may also determine a load impedance estimate based on the plurality of voltages within time intervals.

A method for optimizing a delivered power in a wireless device is also described. The method includes measuring a voltage of a plurality of points within a power/impedance detector. The power/impedance detector includes a directional coupler. The method also includes determining a delivered power estimate. The method also includes determining a load impedance estimate. The method also includes optimizing the delivered power based on the delivered power estimate and the load impedance estimate.

A computer-program product for optimizing a delivered power in a wireless device is also described. The computer-program product includes a non-transitory computer-readable medium having instructions thereon. The instructions include code for causing the wireless device to measure a voltage of a plurality of points within a power/impedance detector. The power/impedance detector includes a directional coupler. The instructions also include code for causing the wireless device to determine a delivered power estimate. The instructions also include code for causing the wireless device to determine a load impedance estimate. The instructions also include code for causing the wireless device to optimize the delivered power based on the delivered power estimate and the load impedance estimate.

An apparatus for optimizing a delivered power in a wireless device is also described. The apparatus includes means for measuring a voltage of a plurality of points within a power/impedance detector. The power/impedance detector includes a directional coupler. The apparatus also includes means for determining a delivered power estimate. The apparatus also includes means for determining a load impedance estimate. The apparatus also includes means for optimizing the delivered power based on the delivered power estimate and the load impedance estimate.

Other aspects, features and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system or method embodiments, it should be understood that such exemplary embodiments can be implemented in various devices, systems and methods.

### DETAILED DESCRIPTION OF ALTERNATIVE & EXEMPLARY EMBODIMENTS

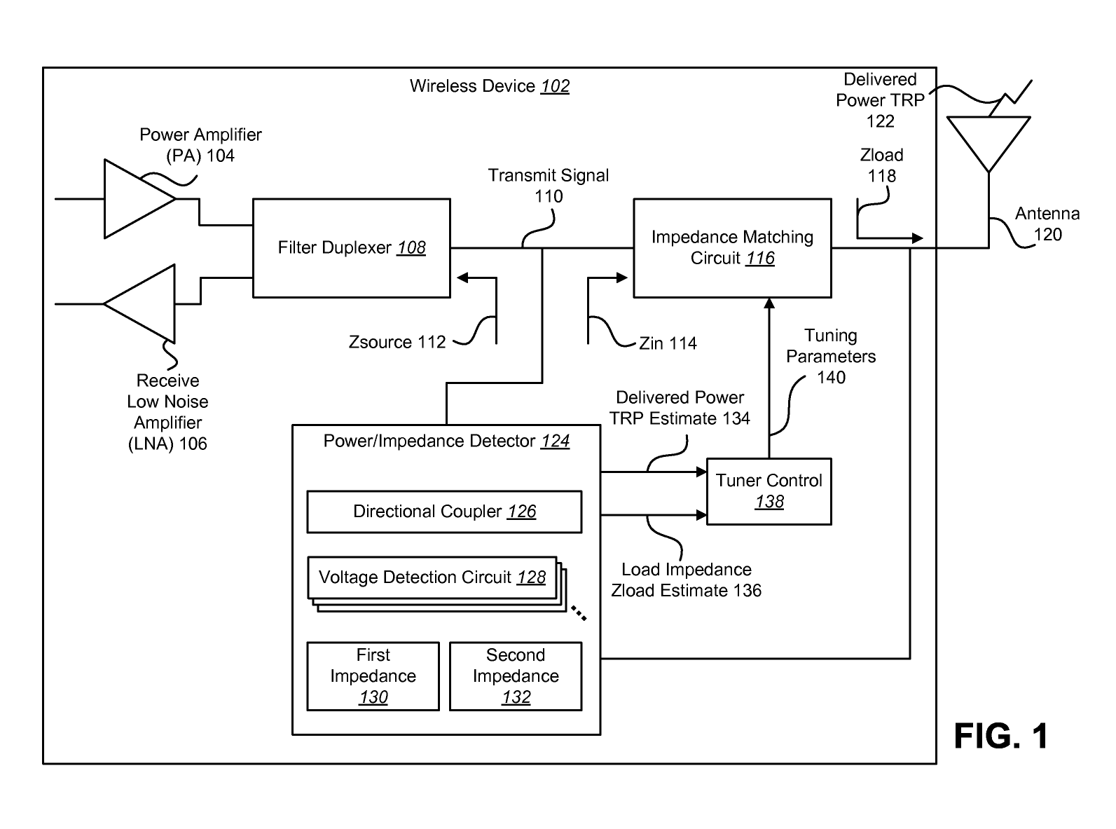

FIG. 1 shows an example of a wireless device 102 in which embodiments of the present invention disclosed herein may be utilized. The wireless device 102 may be a wireless communication device or a base station. The wireless device 102 may include a power/impedance detector 124 that allows the wireless device 102 to maximize the delivered power TRP 122 to an antenna 120 of the wireless device 102.

A wireless communication device may also be referred to as, and may include some or all of the functionality of, a terminal, an access terminal, a user equipment (UE), a subscriber unit, a station, etc. A wireless communication device may be a cellular phone, a personal digital assistant (PDA), a wireless device, a wireless modem, a handheld device, a laptop computer, a PC card, compact flash, an external or internal modem, a wireline phone, etc. A wireless communication device may be mobile or stationary. A wireless communication device may communicate with zero, one or multiple base stations on a downlink and/or an uplink at any given moment. The downlink (or forward link) refers to the communication link from a base station to a wireless communication device, and the uplink (or reverse link) refers to the communication link from a wireless communication device to a base station. Uplink and downlink may refer to the communication link or to the carriers used for the communication link.

A wireless communication device may operate in a wireless communication system that includes other wireless devices, such as base stations. A base station is a station that communicates with one or more wireless communication devices. A base station may also be referred to as, and may include some or all of the functionality of, an access point, a broadcast transmitter, a Node B, an evolved Node B, etc. Each base station provides communication coverage for a particular geographic area. A base station may provide communication coverage for one or more wireless communication devices. The term “cell” can refer to a base station and/or its coverage area, depending on the context in which the term is used.

Communications in a wireless communication system (e.g., a multiple-access system) may be achieved through transmissions over a wireless link. Such a communication link may be established via a single-input and single-output (SISO) or a multiple-input and multiple-output (MIMO) system. A multiple-input and multiple-output (MIMO) system includes transmitter(s) and receiver(s) equipped, respectively, with multiple (NT) transmit antennas and multiple (NR) receive antennas for data transmission. SISO systems are particular instances of a multiple-input and multiple-output (MIMO) system. The multiple-input and multiple-output (MIMO) system can provide improved performance (e.g., higher throughput, greater capacity or improved reliability) if the additional dimensionalities created by the multiple transmit and receive antennas are utilized.

The wireless communication system may utilize both single-input and multiple-output (SIMO) and multiple-input and multiple-output (MIMO). The wireless communication system may be a multiple-access system capable of supporting communication with multiple wireless communication devices by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, single-carrier frequency division multiple access (SC-FDMA) systems, 3rd Generation Partnership Project (3GPP) Long Term Evolution (LTE) systems and spatial division multiple access (SDMA) systems.

The wireless device 102 may include a power amplifier (PA) 104 and a receive low noise amplifier (LNA) 106. The power amplifier (PA) 104 may be part of a transmitter while the receive low noise amplifier (LNA) 106 is part of a receiver. The power amplifier (PA) 104 and the receive low noise amplifier (LNA) 106 may communicate with a filter duplexer 108. In one configuration, the filter duplexer 108 may be replaced with a switch. The output of the power amplifier (PA) 104 may be coupled to the filter duplexer 108. The input of the receive low noise amplifier (LNA) 106 may also be coupled to the filter duplexer 108. The filter duplexer 108 may include a switch coupled to the power amplifier (PA) 104 and the receive low noise amplifier (LNA) 106. Alternatively, the filter duplexer 108 may be a switch coupled to the power amplifier (PA) 104 and the receive low noise amplifier (LNA) 106.

The filter duplexer 108 may include one or more inputs and outputs that permit multi-directional communication over a channel using a single antenna 120. In some configurations, the filter duplexer 108 may be a band-pass duplexer or other type of duplexer for filtering one or more properties of a signal. The filter duplexer 108 may be coupled to an impedance matching circuit 116 and a power/impedance detector 124. The filter duplexer 108 may generate a transmit signal 110 that is provided to a load via the impedance matching circuit 116 and/or the power/impedance detector 124. In some configurations, the load may be an antenna 120.

The transmit signal 110 may be affected by one or more impedance values within the transmit chain (e.g., impedances in the filter duplexer 108 and the impedance matching circuit 116). A source impedance Zsource 112 may be defined as the impedance looking into an output of the filter duplexer 108. An input impedance Zin 114 may be defined as the impedance looking into an input of the impedance matching circuit 116. The impedance matching circuit 116 may be configured or modified to simulate or approximate a circuit with matching values of the source impedance Zsource 112 and the input impedance Zin 114. Creating a matching circuit may eliminate or reduce negative effects, such as power loss, on the transmit signal 110 caused by differences between the source impedance Zsource 112 and the input impedance Zin 114. In modifying the impedance matching circuit 116, it may be useful to obtain information about the transmit signal 110 and the load (e.g., antenna 120).

A power/impedance detector 124 may be used to determine impedance values within the wireless device 102. The power/impedance detector 124 may also be used to determine power properties of the transmit signal 110. The power/impedance detector 124 may determine a delivered power TRP estimate 134 of the delivered power TRP 122 provided to the antenna 120 via the transmit signal 110. The power/impedance detector 124 may also measure a load impedance Zload estimate 136 corresponding to the impedance value of the antenna 120 or other additional circuit elements coupled to the wireless device 102. In some configurations, the delivered power TRP estimate 134 and the load impedance Zload estimate 136 may be used to optimize the impedance matching circuit 116 and maximize the delivered power TRP 122 provided to the antenna 120.

The power/impedance detector 124 may include a directional coupler 126 and one or more voltage detection circuits 128 for measuring voltages of various points within the wireless device 102. The voltage detection circuits 128 may be root means squared (RMS) voltage detection circuits. The directional coupler 126 may receive the transmit signal 110. The directional coupler 126 may couple the transmit signal 110 across multiple points with different strengths and phases, within the directional coupler 126. In some configurations, multiple voltage detection circuits 128 may be coupled to multiple points within/on the directional coupler 126 to obtain a more accurate delivered power TRP estimate 134 and load impedance Zload estimate 136 of the wireless device 102.

The directional coupler 126 may be any variety of directional coupler 126 for coupling a signal. For example, the directional coupler 126 may be a limited directivity directional coupler 126. The directional coupler 126 may couple a portion of the transmit signal 110 from a primary path to a secondary path within the directional coupler 126. In one example, the directional coupler 126 may be a quarter wavelength coupler. In other configurations, other types of directional couplers 126, such as coupled inductors and/or capacitors, may be used in the power/impedance detector 124.

The voltage detection circuits 128 may be coupled to one or more points along the primary path or secondary path of the directional coupler 126. Each voltage detection circuit 128 may measure a voltage at a point. These measured voltage values may be used to determine the delivered power TRP estimate 134 and the load impedance Zload estimate 136. In some configurations, the power/impedance detector 124 may include four voltage detection circuits 128 coupled to four points within the power/impedance detector 124. The power/impedance detector 124 may also include more than four or less than four voltage detection circuits 128 as necessary to determine an accurate load impedance Zload estimate 136 and delivered power TRP estimate 134.

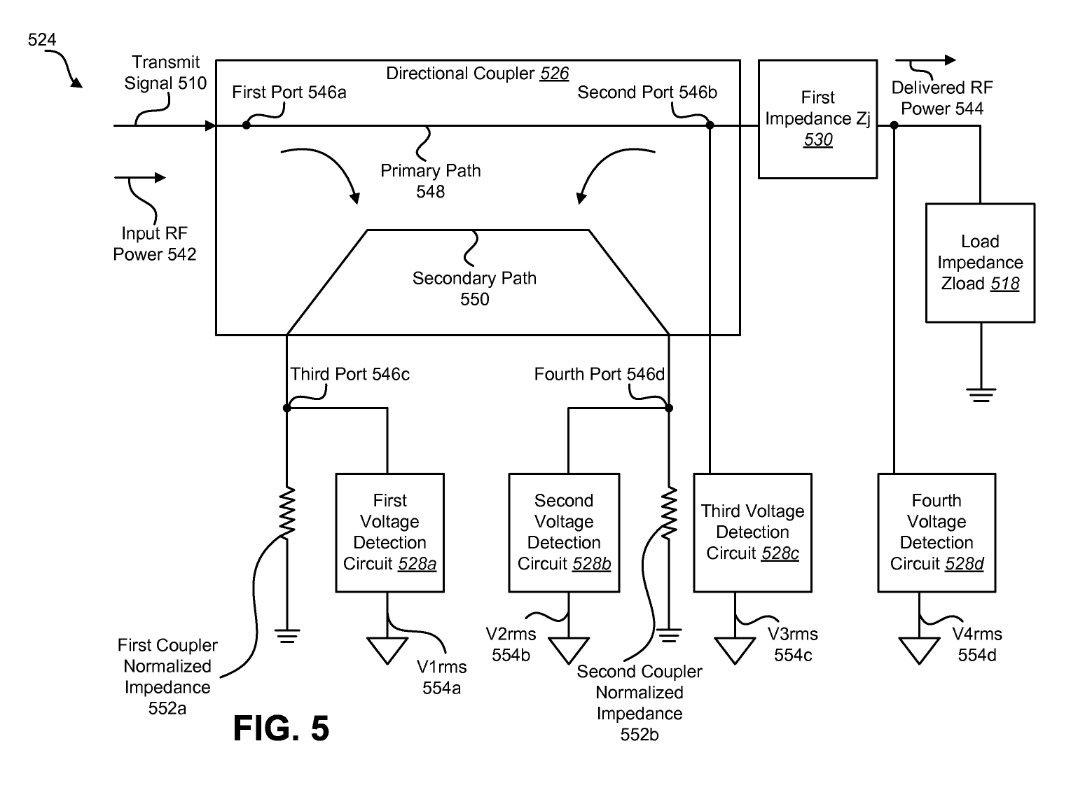

The power/impedance detector 124 may also include one or more impedances to assist in determining the load impedance Zload estimate 136 and the delivered power TRP estimate 134. For example, in one configuration, the power/impedance detector 124 may include a first impedance 130. The first impedance 130 may be placed between the directional coupler 126 and the antenna 120 to create an additional point at which a voltage may be measured. In another configuration, the power/impedance detector 124 may include both a first impedance 130 and a second impedance 132. The first impedance 130 and second impedance 132 may be placed in series between the directional coupler 126 and the antenna 120 to create additional points of measurement. In some cases, having one or more additional points of measurement may improve the accuracy of the load impedance Zload estimate 136 and the delivered power TRP estimate 134. Using a first impedance 130 and a second impedance 132 are discussed in additional detail below in relation to FIGS. 5-8.

The power/impedance detector 124 may be coupled to a tuner control 138. The power/impedance detector 124 may provide the delivered power TRP estimate 134 and the load impedance Zload estimate 136 to the tuner control 138. The tuner control 138 may receive these values and generate tuning parameters 140 for adjusting or modifying one or more components within the impedance matching circuit 116. These tuning parameters 140 may be provided to the impedance matching circuit 116 to optimize and/or maximize the delivered power TRP 122 provided to the antenna 120. In one configuration, the tuning parameters 140 may be used to adjust one or more impedance values within the impedance matching circuit 116 to minimize the difference between the source impedance Zsource 112 and input impedance Zin 114. By matching the source impedance Zsource 112 and input impedance Zin 114, the delivered power TRP 122 provided to the antenna 120 may be maximized.

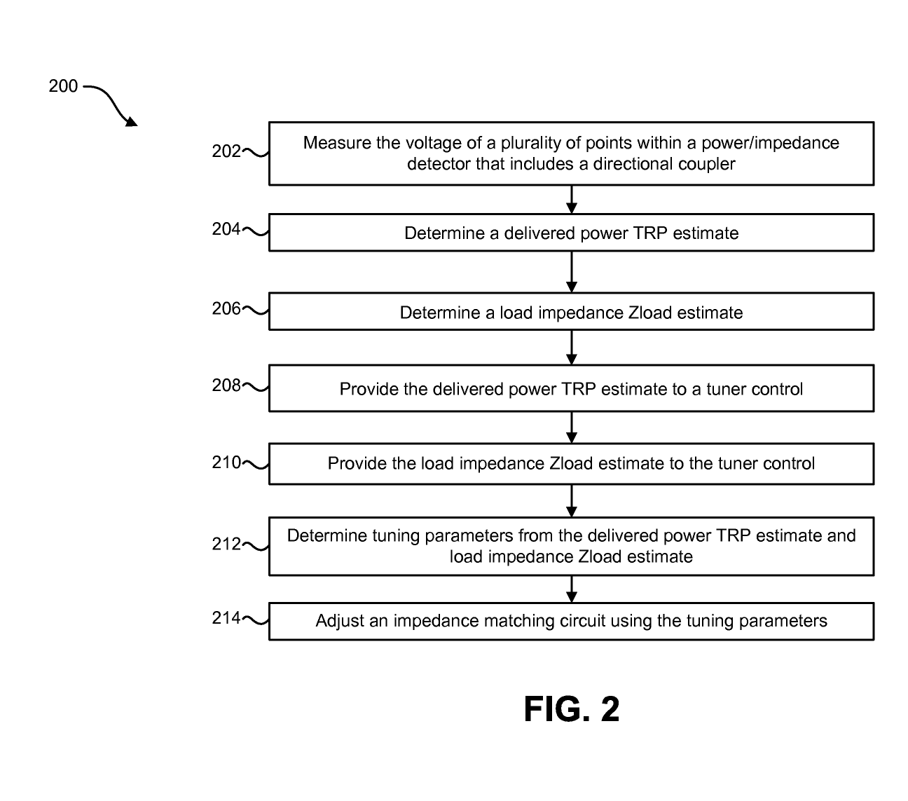

FIG. 2 is a flow diagram of a method 200 for determining a delivered power TRP estimate 134 and a load impedance Zload estimate 136 using a directional coupler 126 according to some embodiments of the present invention. The method 200 may be performed by a wireless device 102 or similar electronic device that includes a load impedance Zload 118. The wireless device 102 may measure 202 the voltage of a plurality of points within a power/impedance detector 124. The power/impedance detector 124 may include a directional coupler 126. In one configuration, the power/impedance detector 124 may measure the voltage of multiple points within the power/impedance detector 124 using multiple voltage detection circuits 128. For example, multiple voltage detection circuits 128 may measure one or more points on or around the directional coupler 126.

The wireless device 102 may determine 204 a delivered power TRP estimate 134. The delivered power TRP estimate 134 may correspond to the delivered power TRP 122 provided to a load within the wireless device 102. In one example, the load may be an antenna 120 within or attached to the wireless device 102. Determining a delivered power TRP estimate 134 may include obtaining one or more measured voltages using the voltage detection circuits 128 and calculating the delivered power TRP estimate 134 based on the measured voltages. Determining a delivered power TRP estimate 134 may be a function of an incident power and reflected power passing through a point of the wireless device 102. The incident power may be the power of the transmit signal 110 as it passes into the antenna 120. The reflected power may be the power of the reflected signal that is reflected from the antenna 120 (i.e., not delivered to the antenna 120). In one configuration, the incident and reflected power measurements may be determined by the voltage detection circuits 128 coupled to various points on or around the directional coupler 126. The delivered power TRP 122 may be calculated using Equation (1):

TRP=P_{inc}−P_{refl}. (1)

In Equation (1), Pinc represents a measurement of the incident power and Prefl represents a measurement of the reflected power.

The wireless device 102 may also determine 206 a load impedance Zload estimate 136. The load impedance Zload estimate 136 may correspond to the impedance of an antenna 120 or other load of the wireless device 102. As discussed above, the load impedance Zload 118 may be the measured impedance towards the antenna 120 or other load from the output of the impedance matching circuit 116 and the output of the power/impedance detector 124. The value of the load impedance Zload 118 may be affected by properties of the wiring within the wireless device 102, properties of the antenna 120, proximity to an object, pressure, voltage and temperature (PVT) fluctuations, processing variations and/or atmospheric influences. In some configurations, the wireless device 102 may be configured to dynamically monitor a plurality of measured voltages and determine the delivered power TRP estimate 134 and the load impedance Zload estimate 136 at periodic intervals. The wireless device 102 may frequently update the delivered power TRP estimate 134 and the load impedance Zload estimate 136 to reflect changes that may vary according to time and according to the transmit signal 110. The wireless device 102 may optimize the delivered power TRP 122 by performing additional operations. The additional operations may be performed using the delivered power TRP estimate 134 and the load impedance Zload estimate 136.

The wireless device 102 may provide 208 the delivered power TRP estimate 134 to a tuner control 138. The wireless device 102 may also provide 210 the load impedance Zload estimate 136 to the tuner control 138. The wireless device 102 may then consider both the delivered power TRP estimate 134 and the load impedance Zload estimate 136 to optimize the delivered power TRP 122 of the wireless device 102. For example, the wireless device 102 may determine 212 tuning parameters 140 from the delivered power TRP estimate 134 and load impedance Zload estimate 136 provided to the tuner control 138. The tuner control 138 may determine 212 one or more tuning parameters 140 that may be applied to the impedance matching circuit 116 for optimizing the delivered power TRP 122 provided to the antenna 120. In approaches where the delivered power TRP estimate 134 and load impedance Zload estimate 136 values are being monitored continuously or periodically within various time intervals, the tuner control 138 may be configured to update or determine tuning parameters 140 that reflect values that would maximize the delivered power TRP 122 of the wireless device 102 at different points in time.

The wireless device 102 may adjust 214 an impedance matching circuit 116 using the tuning parameters 140. For example, the impedance matching circuit 116 may include various impedance elements (e.g., resistors, capacitors, inductors) that may be adjusted to minimize the difference between the source impedance Zsource 112 and the input impedance Zin 114. By adjusting the values of the impedance matching circuit 116 to reflect the tuning parameters 140 derived from the delivered power TRP estimate 134 and the load impedance Zload estimate 136, the wireless device 102 may maximize the delivered power TRP 122 provided to the antenna 120. Because both the delivered power TRP estimate 134 and the load impedance Zload estimate 136 are considered, the accuracy of the tuning parameters 140 used to adjust the impedance matching circuit 116 may be improved, and a higher delivered power TRP 122 to the antenna 120 may be achieved.

Further benefits of considering both the delivered power TRP estimate 134 and the load impedance Zload estimate 136 may include more accurate measurements when large load reflections are present and greater accuracy while implementing a simple impedance matching circuit 116 design. Determining the delivered power TRP estimate 134 and load impedance Zload estimate 136 may include a variety of implementations of the power/impedance detector 124 as well as various calculations and methods corresponding to each implementation. Additional examples and implementations for determining the delivered power TRP estimate 134 and load impedance Zload estimates 136 are described in more detail below.

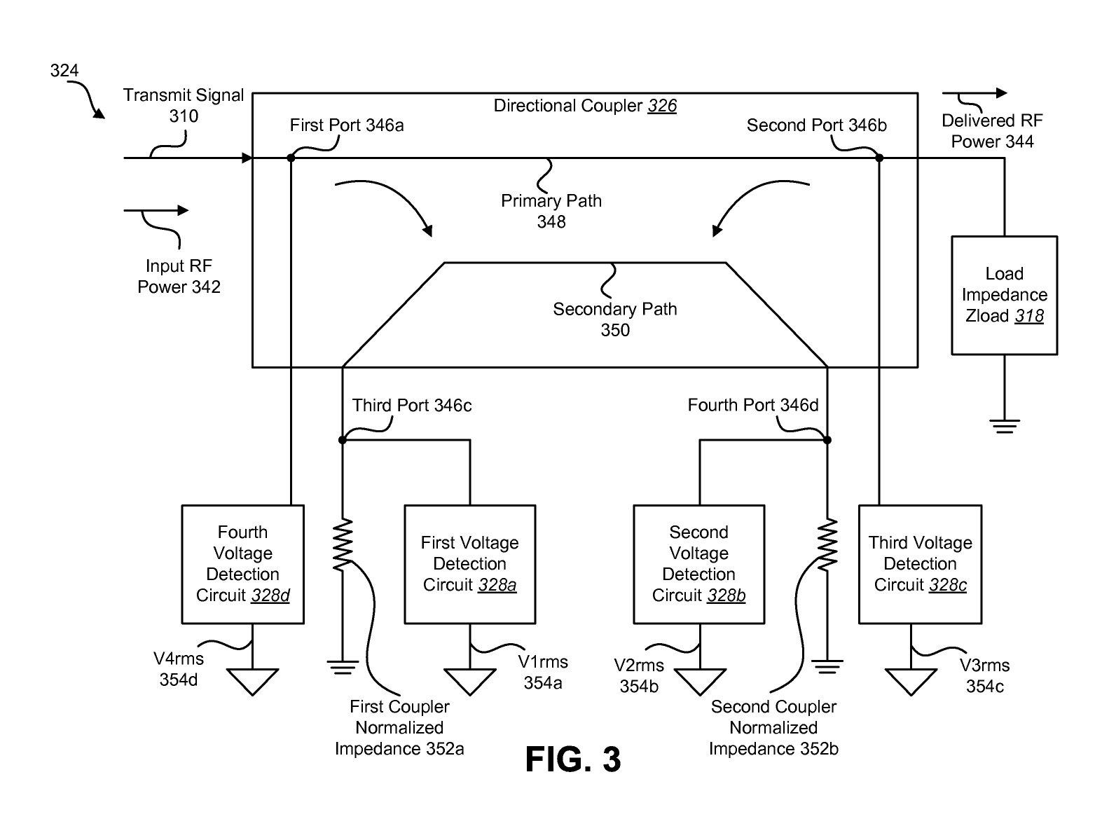

FIG. 3 is a block diagram of a power/impedance detector 324 according to some embodiments of the present invention. The power/impedance detector 324 of FIG. 3 may be one configuration of the power/impedance detector 124 of FIG. 1. The power/impedance detector 324 may include a directional coupler 326 with four ports 346a-d. In some configurations, the directional coupler 326 may be a directional coupler 326 with limited directivity.

The first port 346a may be coupled to an input of the directional coupler 326. The second port 346b may be coupled to an output of the directional coupler 326. The first port 346a may be coupled to the second port 346b via a primary path 348. The second port 346b may be coupled to ground through a load impedance Zload 318. The load impedance Zload 318 may be a model of the impedance of an antenna 120. The third port 346c may be coupled to the fourth port 346d via a secondary path 350. The third port 346c may be coupled to ground via a first coupler normalized impedance 352a. The fourth port 346d may be coupled to ground via a second coupler normalized impedance 352b.

The directional coupler 326 may receive a transmit signal 310 with an input RF power 342 at the first port 346a. A portion of the transmit signal 310 may pass between the first port 346a and the second port 346b along the primary path 348 of the directional coupler 326. The directional coupler 326 may couple a portion of the transmit signal 310 from the primary path 348 to the secondary path 350. The directional coupler 326 may then output the transmit signal 310 via the second port 346b. The transmit signal 310 may be provided to the load impedance Zload 318. The directional coupler 326 may output the transmit signal 310 with a delivered RF power 344. The delivered RF power 344 may be a representation of the delivered power TRP 122 of FIG. 1.

The power/impedance detector 324 may further include a plurality of voltage detection circuits 328 coupled to multiple points within the power/impedance detector 324. In some configurations, the plurality of voltage detection circuits 328 may be root means squared (RMS) voltage detection circuits. A first voltage detection circuit 328a may be coupled to the third port 346c of the directional coupler 326. The first voltage detection circuit 328a may measure a first voltage V1rms 354a. A second voltage detection circuit 328b may be coupled to the fourth port 346d of the directional coupler 326. The second voltage detection circuit 328b may measure a second voltage V2rms 354b.

A third voltage detection circuit 328c may be coupled to the second port 346b of the directional coupler 326. The third voltage detection circuit 328c may measure a third voltage V3rms 354c. A fourth voltage detection circuit 328d may be coupled to the first port 346a of the directional coupler 326. The fourth voltage detection circuit 328d may measure a fourth voltage V4rms 354d.

Each of the measured voltages V1rms-V4rms 354a-d may be used to determine a delivered power TRP estimate 134 and a load impedance Zload estimate 136. Various approaches may be implemented for determining the delivered power TRP estimate 134 and the load impedance Zload estimate 136. For example, the incident power Pinc may be calculated using Equation (2):

$${P}_{inc} = \frac{{C}_{f}}{50} \cdot ( {V}_{1 rms}^{2} - 2 {D}_{f} \cdot cos ( φ - θ ) {V}_{1 rms} {V}_{2 rms} + {D}_{f}^{2} {V}_{2 rms}^{2} ) . \qquad ( 2 )$$

In Equation (2), Cf represents a capacitance at the first port 346a of the directional coupler 326. Df represents the directivity of the first port 346a of the directional coupler. φ corresponds to the phase of an incident signal and θ corresponds to the phase of a reflected signal.

The reflected power Prefl may be calculated using Equation (3):

$${P}_{refl} = \frac{{C}_{r}}{50} \cdot ( {V}_{2 rms}^{2} - {D}_{r} \cdot ( {V}_{3 rms}^{2} - {V}_{4 rms}^{2} - {V}_{2 rms}^{2} ) + {D}_{r}^{2} {V}_{1 rms}^{2} ) . \qquad ( 3 )$$

In Equation (3), Cr represents a capacitance value at the second port 346b of the directional coupler 326 and Dr represents the directivity at the second port 346b of the directional coupler 326. Equation (2) and Equation (3) may be used in Equation (1) to determine the delivered power TRP estimate 134.

The load impedance Zload 318 may be calculated using Equation (4):

$${Z}_{load} = 50 \cdot \frac{1 + {Γ}_{load}}{1 - {Γ}_{load}} . \qquad ( 4 )$$

In Equation (4), Γload represents the reflection at the load impedance Zload 318. The 50 Ohm value represents a default characteristic impedance of an RF transmission line.

The reflection Γload may be calculated using Equation (5):

$${Γ}_{load} = \sqrt{\frac{{P}_{refl}}{{P}_{inc}}} \cdot {e}^{j φ \cdot sign} . \qquad ( 5 )$$

In Equation (5), the sign value corresponds to the sign of a signal at the output of the directional coupler 326 and is assumed to be much less than a quarter wavelength. The incident power Pinc, reflection power Rrefl and reflection Γload may be used to determine the delivered power TRP estimate 134 and load impedance Zload estimate 136.

A value for the Df parameter used in Equation (2) may be calculated using Equation (6):

$${D}_{f} \cdot {e}^{j θ} = \frac{{S}_{32}}{{S}_{31}} . \qquad ( 6 )$$

In Equation (6), Sxy represents an S-parameter (i.e., a scattering parameter in a scattering matrix) between specific ports of the directional coupler 326 (e.g., ports x, y). S₃₂ represents the response at the third port 346c due to the signal at the second port 346b. S₃₁ represents the response at the third port 346c due to the signal at the first port 346a.

A value for the Dr parameter used in Equation (3) may be calculated using Equation (7):

$${D}_{r} = \vert \frac{{S}_{41}}{{S}_{42}} \vert . \qquad ( 7 )$$

In Equation (7), S₄₁ represents the response at the fourth port 346d due to the signal at the first port 346a. S₄₂ represents the response at the fourth port 346d due to the signal at the second port 346b. With regard to Equations (6) and (7), the assumption is made that ∠S₃₁≈∠S₄₂≈90°.

A value for φ used in Equations (2) and (5) may also be calculated using Vrms values. For example, φ may be calculated using Equation (8):

$$φ = arccos ( \frac{{V}_{3 rms}^{2} - {V}_{1 rms}^{2} - {V}_{2 rms}^{2}}{2 \cdot {V}_{1 rms} {V}_{2 rms}} ) . \qquad ( 8 )$$

The sign value for the directional coupler 326 used in Equation (5) may be calculated using Equation (9):

$$sign \approx \frac{\vert {V}_{4 rms} - {V}_{3 rms} \vert}{{V}_{4 rm s} - {V}_{3 rm s}} . \qquad ( 9 )$$

In Equation (9), an assumption is made that the sign value for the directional coupler 326 is much less than a quarter wavelength.

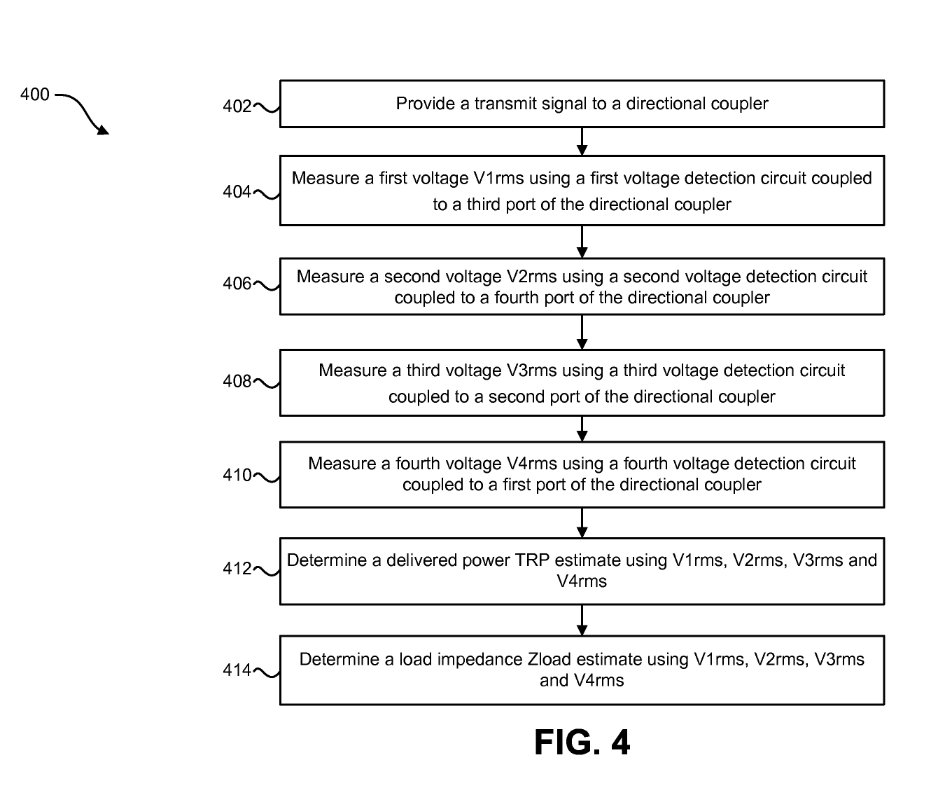

FIG. 4 is a flow diagram of another method 400 for determining a delivered power TRP estimate 134 and a load impedance Zload estimate 136 using a directional coupler 326. The method 400 may be performed by a wireless device 102 or similar electronic device that includes an antenna 120 and a power/impedance detector 324. As discussed above, the antenna 120 may be modeled as a load impedance Zload 318. The wireless device 102 may provide 402 a transmit signal 310 to the directional coupler 326. The directional coupler 326 may couple a portion of the transmit signal 310 from a primary path 348 to a secondary path 350 of the directional coupler 326. The directional coupler 326 may be coupled to multiple voltage detection circuits 328 that measure the voltage at multiple points within the power/impedance detector 324. In some configurations, the voltage detection circuits 329 may be root means squared (RMS) voltage detection circuits.

The power/impedance detector 324 may measure 404 a first voltage V1rms 354a using a first voltage detection circuit 328a. The first voltage detection circuit 328a may be coupled to a third port 346c of the directional coupler 326. The power/impedance detector 324 may measure 406 a second voltage V2rms 354b using a second voltage detection circuit 328b. The second voltage detection circuit 328b may be coupled to a fourth port 346d of the directional coupler 326.

The power/impedance detector 324 may measure 408 a third voltage V3rms 354c using a third voltage detection circuit 328c. The third voltage detection circuit 328c may be coupled to a second port 346b of the directional coupler 326. The power/impedance detector 324 may measure 410 a fourth voltage V4rms 354d using a fourth voltage detection circuit 328d. The fourth voltage detection circuit 328d may be coupled to a first port 346a of the directional coupler 326.

The power/impedance detector 324 may determine 412 a delivered power TRP estimate 134 using V1rms 354a, V2rms 354b, V3rms 354c and V4rms 354d. The power/impedance detector 324 may determine 414 a load impedance Zload estimate 136 using V1rms 354a, V2rms 354b, V3rms 354c and V4rms 354d. In determining the delivered power TRP estimate 134 and the load impedance Zload estimate 136, various approaches and calculations may be used, including those discussed above in relation to FIG. 3.

FIG. 5 is a block diagram of another power/impedance detector 524 according to some embodiments of the present invention. The power/impedance detector 524 of FIG. 5 may be one configuration of the power/impedance detector 124 of FIG. 1. The power/impedance detector 524 may include a directional coupler 526 with four ports 546a-b. In some configurations, the directional coupler 526 may be a directional coupler 526 with limited directivity.

The first port 546a may be coupled to an input of the directional coupler 526. The second port 546b may be coupled to an output of the directional coupler 526. The first port 546a may be coupled to the second port 546b via a primary path 548. The second port 546b may be coupled to ground through a load impedance Zload 518. The load impedance Zload 518 may model the impedance of an antenna 120. The third port 546c may be coupled to the fourth port 546d via a secondary path 550. The directional coupler 526 may provide coupling from the primary path 548 to the secondary path 550. The third port 546c may be coupled to ground via a first coupler normalized impedance 552a. The fourth port 546d may be coupled to ground via a second coupler normalized impedance 552b.

The directional coupler 526 may receive a transmit signal 510 with an input RF power 542 at the first port 546a. A portion of the transmit signal 510 may pass between the first port 546a and the second port 546b along the primary path 548 of the directional coupler 526. The directional coupler 526 may couple a portion of the transmit signal 510 from the primary path 548 to the secondary path 550. The directional coupler 526 may then output the transmit signal 510 via the second port 546b. The transmit signal 510 may be provided to the load impedance Zload 518 via a first impedance Zj 530. The transmit signal 510 output from the first impedance Zj 530 may have a delivered RF power 544. The delivered RF power 544 may be one configuration of the delivered power TRP 122 of FIG. 1.

The power/impedance detector 524 may further include a plurality of voltage detection circuits 528a-d coupled to multiple points within the power/impedance detector 524. In some configurations, the plurality of voltage detection circuits 528 may be root means squared (RMS) voltage detection circuits. A first voltage detection circuit 528a may be coupled to the third port 546c of the directional coupler 526. The first voltage detection circuit 528a may measure a first voltage V1rms 554a. A second voltage detection circuit 528b may be coupled to the fourth port 546d of the directional coupler 526. The second voltage detection circuit 528b may measure a second voltage V2rms 554b. A third voltage detection circuit 528c may be coupled to the second port 546b of the directional coupler 526. The third voltage detection circuit 528c may measure a third voltage V3rms 554c.

The second port 546b of the directional coupler 526 may be coupled to the first impedance Zj 530. The first impedance Zj 530 may include one or more impedance elements (e.g., resistors, capacitors, inductors). The first impedance Zj 530 may be coupled between the second port 546b and the load impedance Zload 518. In one configuration, the first impedance Zj 530 may include a capacitor in series between the second port 546b of the directional coupler 526 and the load impedance Zload 518.

The power/impedance detector 524 may include a fourth voltage detection circuit 528d coupled to a point between the first impedance Zj 530 and the load impedance Zload 518. The fourth voltage detection circuit 528d may measure a fourth voltage V4rms 554d.

Each of the measured voltages V1rms-V4rms 554a-d may be used to determine a delivered power TRP estimate 134 and a load impedance Zload estimate 136. Various approaches may be implemented for determining the delivered power TRP estimate 134 and the load impedance Zload estimate 136. For example, the delivered power TRP estimate 134 and the load impedance Zload estimate 136 at the load may be determined by first calculating power and impedance properties at the output of the directional coupler 526. Power and impedance properties at the output of the directional coupler 526 may be calculated using Equations (1)-(8) where TRP calculated in Equation (1) represents the delivered power RF power 544 at the output of the first impedance Zj 530. The sign of the signal at the output of the directional coupler 526 may be determined using Equation (10):

$$sign \approx \frac{\vert \frac{{V}_{4 rms}}{{V}_{3 rms}} - 1 \vert}{\frac{{V}_{4 rms}}{{V}_{3 rms}} - 1} . \qquad ( 10 )$$

In the power/impedance detector 524 of FIG. 5, the delivered RF power 544 Pdelivered to the load impedance Zload 518 may be calculated using Equation (11):

P_{delivered}_{_{—}}_{load}=P_{delivered}_{_{—}}_{cpl}. (11)

In Equation (11), Pdelivered_cpl represents the input RF power 542. The delivered power TRP estimate 134 and load impedance Zload estimate 136 may be determined by calculating the load reflection Γload. The load reflection Γload may be determined using Equation (12):

$${Γ}_{load} = \frac{1}{{S}_{Z}} - \frac{4}{{Γ}_{cpl} + 3 {S}_{Z}} . \qquad ( 12 )$$

In Equation (12), Γload represents the reflection at the load impedance Zload 518. Γcpl represents the reflection at the output of the directional coupler 526. The reflection Γload calculated in Equation (12) may be used in Equation (4) to calculate the load impedance Zload 518. Further, Sz is an intermediate variable calculated using Equation (13):

$${S}_{Z} = \frac{j Z}{j Z + 100} . \qquad ( 13 )$$

In Equation (13), jZ represents the impedance value of the first impedance Zj 530. The 100 Ohm value represents the 50 Ohm impedance value of two RF transmission lines.

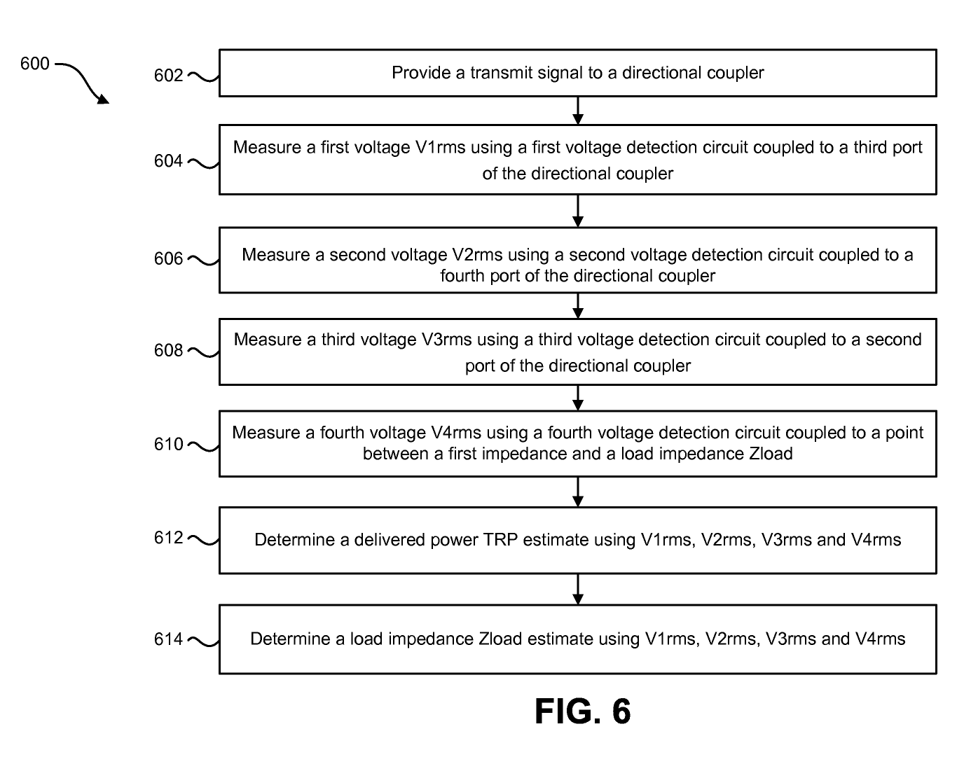

FIG. 6 is a flow diagram of a method 600 for determining a delivered power TRP estimate 134 and a load impedance Zload estimate 136 using a directional coupler 526 and a first impedance Zj 530. The method 600 may be performed by a wireless device 102 or similar electronic device that includes a power/impedance detector 124 and an antenna 120 modeled as a load impedance Zload 518. The wireless device 102 may provide 602 a transmit signal 510 to the directional coupler 526. The directional coupler 526 may couple a portion of the transmit signal 510 from a primary path 548 to a secondary path 550 of the directional coupler 526. Multiple voltage detection circuits 528 may measure the voltage at multiple points within the power/impedance detector 524. An output of the directional coupler 526 may be coupled to a first impedance Zj 530. The first impedance Zj 530 may be coupled between the output of the directional coupler 526 and the load impedance Zload 518. In some configurations, the first impedance Zj 530 may be a capacitor in series between the second port 546b and the load impedance Zload 518.

The power/impedance detector 524 may measure 604 a first voltage V1rms 554a using a first voltage detection circuit 528a. The first voltage detection circuit 528a may be coupled to a third port 546c of the directional coupler 526. The power/impedance detector 524 may measure 606 a second voltage V2rms 554b using a second voltage detection circuit 528b. The second voltage detection circuit 528b may be coupled to a fourth port 546d of the directional coupler 526. The power/impedance detector 524 may measure 608 a third voltage V3rms 554c using a third voltage detection circuit 528c. The third voltage detection circuit 528c may be coupled to a second port 546b of the directional coupler 526.

The power/impedance detector 524 may measure 610 a fourth voltage V4rms 554d using a fourth voltage detection circuit 528d. The fourth voltage detection circuit 528d may be coupled between the first impedance Zj 530 and the load impedance Zload 518.

The power/impedance detector 524 may determine 612 a delivered power TRP estimate 134 using V1rms 564a, V2rms 564b, V3rms 564c and V4rms 564d. The power/impedance detector 524 may also determine 614 a load impedance Zload estimate 136 using V1rms 564a, V2rms 564b, V3rms 564c and V4rms 564d. In determining the delivered power TRP estimate 134 and the load impedance Zload estimate 136, various approaches and calculations may be used, including those discussed above in relation to FIGS. 3 and 5.

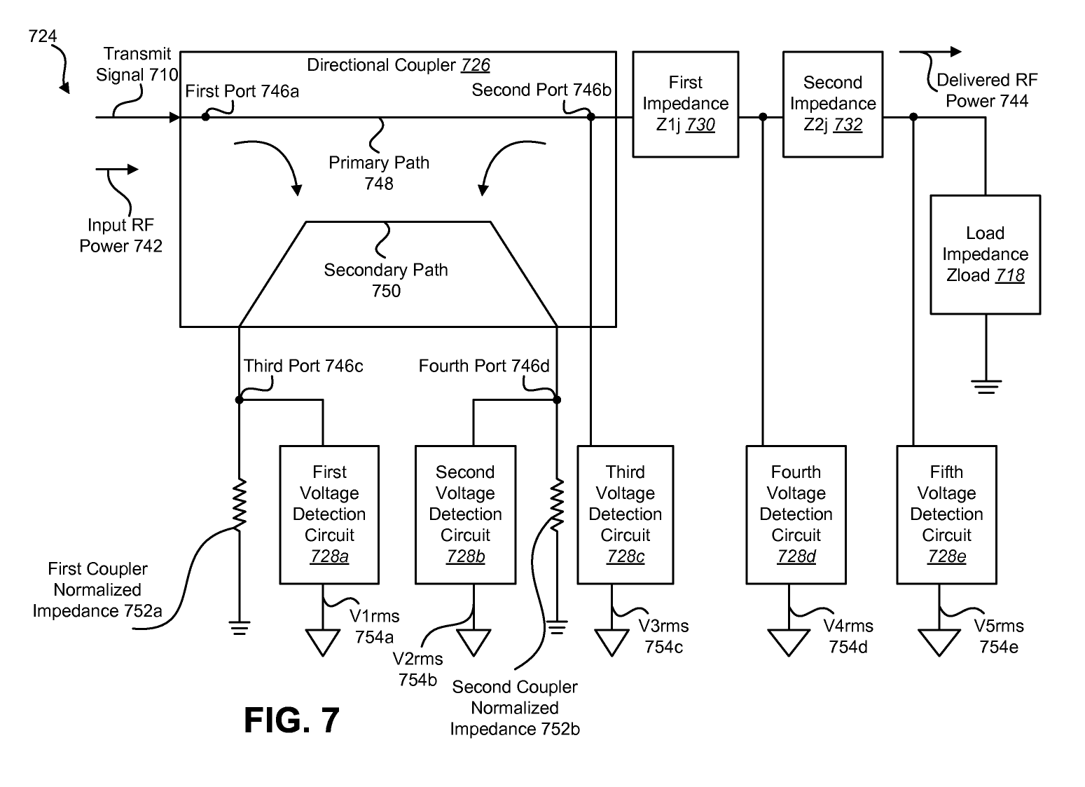

FIG. 7 is a block diagram of yet another power/impedance detector 724 according to some embodiments of the present invention. The power/impedance detector 724 of FIG. 7 may be one configuration of the power/impedance detector 124 of FIG. 1. The power/impedance detector 724 may include a directional coupler 726 with four ports 746a-d. In some configurations, the directional coupler 726 may be a directional coupler 726 with limited directivity. The power/impedance detector 724 may also include both a first impedance Z1j 730 and a second impedance Z2j 732.

The first port 746a may be coupled to an input of the directional coupler 726. The second port 746b may be coupled to an output of the directional coupler 726. The first port 746a may be coupled to the second port 746b via a primary path 748. The third port 746c may be coupled to the fourth port 746d via a secondary path 750. The directional coupler 726 may provide coupling from the primary path 748 to the secondary path 750. The third port 746c may be coupled to ground via a first coupler normalized impedance 752a. The fourth port 746d may be coupled to ground via a second coupler normalized impedance 752b.

The directional coupler 726 may receive a transmit signal 710 with an input RF power 742 at the first port 746a. A portion of the transmit signal 710 may pass between the first port 746a and the second port 746b along the primary path 748 of the directional coupler 726. The directional coupler 726 may couple a portion of the transmit signal 710 from the primary path 748 to the secondary path 750. The directional coupler 726 may then output the transmit signal 710 via the second port 746b. The transmit signal 710 may be provided to the load impedance Zload 718 via the first impedance Z1j 730 and the second impedance Z2j 732. The second impedance Z2j 732 may output the transmit signal 710 with a delivered RF power 744. The delivered RF power 744 may be a representation of the delivered power TRP 122 of FIG. 1.

The power/impedance detector 724 may further include a plurality of voltage detection circuits 728 coupled to multiple points within the power/impedance detector 724. In some configurations, the plurality of voltage detection circuits 728 may be root means squared (RMS) voltage detection circuits. A first voltage detection circuit 728a may be coupled to the third port 746c of the directional coupler 726. The first voltage detection circuit 728a may measure a first voltage V1rms 754a. A second voltage detection circuit 728b may be coupled to the fourth port 746d of the directional coupler 726. The second voltage detection circuit 728b may measure a second voltage V2rms 754b. A third voltage detection circuit 728c may be coupled to the second port 746b of the directional coupler 726. The third voltage detection circuit 728c may measure a third voltage V3rms 754c.

The second port 746b of the directional coupler 726 may be coupled to the first impedance Z1j 730. The first impedance Z1j 730 may be coupled to the second impedance Z2j 732. The second impedance Z2j 732 may be coupled to the load impedance Zload 718. The first impedance Z1j 730 may include one or more impedance elements (e.g., resistors, capacitors, inductors). The second impedance Z2j 732 may also include one or more impedance elements. In some configurations, the first impedance Z1j 730 and the second impedance Z2j 732 may have similar impedance values.

The power/impedance detector 724 may include a fourth voltage detection circuit 728d coupled between the first impedance Z1j 730 and the second impedance Z2j 732. The fourth voltage detection circuit 728d may measure a fourth voltage V4rms 754d. The power impedance detector 724 may also include a fifth voltage detection circuit 728e coupled between the second impedance Z2j 732 and the load impedance Zload 718. The fifth voltage detection circuit 728e may measure a fifth voltage V5rms 754e.

Each of the measured voltages V1rms-V5rms 754a-e may be used to determine a delivered power TRP estimate 134 and a load impedance Zload estimate 136. Various approaches may be implemented for determining the delivered power TRP estimate 134 and the load impedance Zload estimate 136. The delivered power TRP estimate 134 and the load impedance Zload estimate 136 may be calculated by first determining the delivered power TRP and the impedance at the output of the directional coupler 726. The delivered power Pdelivered_cpl, reflection Γcpl and incident power at the coupler Pinc_cpl may be calculated using Equations (1)-(8) and Equation (10) described above. In Equations (1)-(8) and (10), Pdelivered_cpi may correspond to Pdelivered of Equation (1), Pinc_cpl may correspond to Pinc of Equation (2) and Γcpl may correspond to Γload of Equation (5).

The load impedance Zload estimate 136 may be calculated using equation (14):

$${Z}_{load} = \frac{1}{B + j G} . \qquad ( 14 )$$

In Equation (14), B represents the real component of Zload. B may be calculated using Equation (15):

$$B = \frac{- 1}{Z} \cdot ( \frac{{\vert {V}_{rms 4} \vert}^{2}}{{\vert {V}_{rms 5} \vert}^{2}} - \frac{{\vert {V}_{rms 3} \vert}^{2}}{4 \cdot {\vert {V}_{rms 5} \vert}^{2}} - \frac{3}{4} ) . \qquad ( 15 )$$

In Equation (15), it is assumed that the first impedance and second impedance have equal impedance values represented by Z.

Referring to Equation (14), G represents the imaginary value of Zload and may be calculated using Equation (16):

$$G = \sqrt{{( B + 1 )}^{2} + \frac{{\vert {V}_{rms 4} \vert}^{2}}{{\vert {V}_{rms 5} \vert}^{2}} \cdot \frac{1}{Z}} . \qquad ( 16 )$$

In Equation (16), it is assumed that the first impedance and second impedance have equal impedance values represented by Z.

Using the values above, the load reflection Γ′load may be calculated using Equation (17):

$${Γ}_{load}^{′} = \frac{50 - {Z}_{load}}{50 + {Z}_{load}} . \qquad ( 17 )$$

In Equation (17), Γ′load represents the reflection of the load when using a first impedance Z1j 730 and a second impedance Z2j 732 similar to those described in relation to FIG. 7. The 50 Ohm value represents a default characteristic impedance of an RF transmission line.

The delivered power TRP estimate 134 and the load impedance Zload estimate 136 may be determined by calculating the reflection, delivered power TRP and incident power. The reflection F may be calculated using Equation (18):

Γ_{load}=|Γ″_{load}|∠Γ′_{load}. (18)

In Equation (18), Γload represents the final reflection at the load impedance Zload 718. Γ″load represents the reflection calculated by using Equations (10), (12) and (13). Γ′load represents the reflection calculated in Equation (17).

The delivered power TRP may be calculated using Equation (19):

P_{delivered}=P_{delivered}_{_{—}}_{cpl}. (19)

In Equation (19), Pdelivered represents a calculation of the delivered power TRP at the load. Pdelivered_cpi represents a calculation of the delivered power TRP at the output of the directional coupler.

The incident power Pinc may be calculated using Equation (20):

$${P}_{inc} = \frac{{P}_{delivered}}{1 - {\vert {Γ}_{load}^{″} \vert}^{2}} . \qquad ( 19 )$$

In Equation (20), Pinc represents the incident power from the directional coupler 726. Pdelivered represents the delivered power TRP to the load impedance Zload 718. Γ″load represents the load reflection calculated using Equation (12).

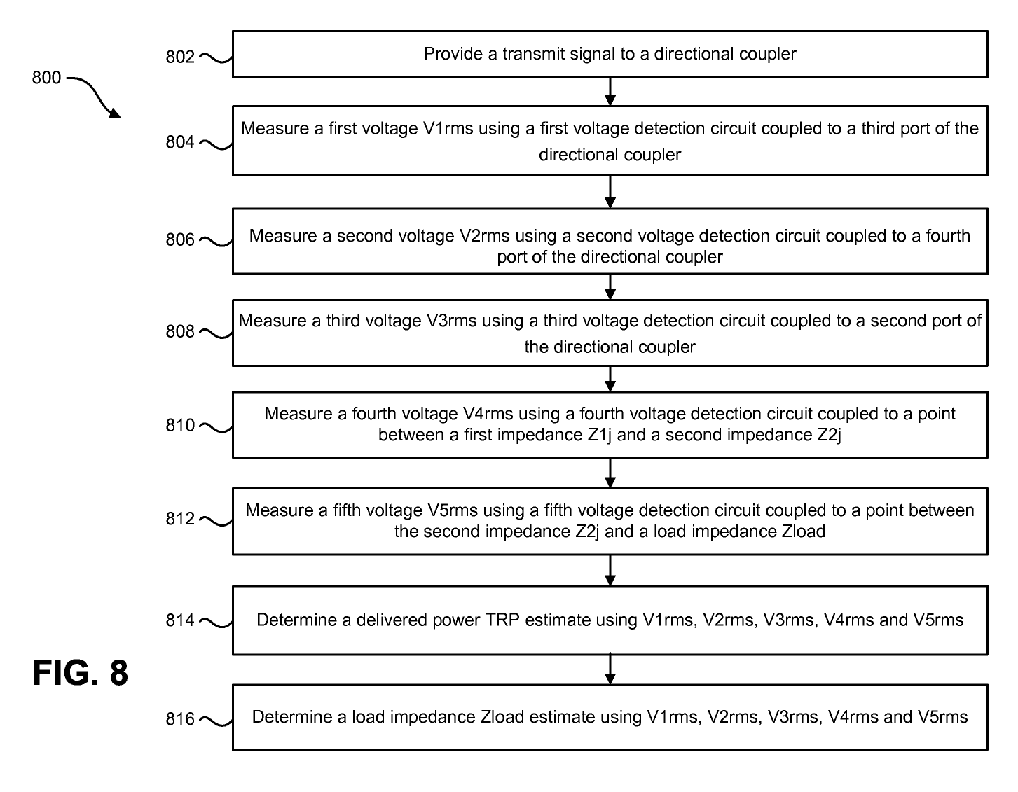

FIG. 8 is a flow diagram of another method 800 for determining a delivered power TRP estimate 134 and a load impedance Zload estimate 136 using a directional coupler 726, a first impedance 730 and a second impedance 732. The method 800 may be performed by a wireless device 102 or similar electronic device that includes an antenna 720 and a power/impedance detector 724. As discussed above, the antenna 120 may be modeled as a load impedance Zload 718. The wireless device 102 may provide 802 a transmit signal 710 to the directional coupler 726. The directional coupler 726 may couple a portion of the transmit signal 710 from a primary path 748 to a secondary path 750. The directional coupler 726 may be coupled to multiple voltage detection circuits 728 that measure the voltage at multiple points within a power/impedance detector 724. In some configurations, the multiple voltage detection circuits 728 may be root means squared (RMS) voltage detection circuits. The directional coupler 726 may be coupled to a first impedance Z1j 730. The first impedance Z1j 730 may be coupled to a second impedance Z2j 732. The second impedance Z2j 732 may be coupled to the load impedance Zload 718.

The power/impedance detector 724 may measure 804 a first voltage V1rms 754a using a first voltage detection circuit 728a. The first voltage detection circuit 728a may be coupled to a third port 746c of the directional coupler 726. The power/impedance detector 724 may measure 806 a second voltage V2rms 754b using a second voltage detection circuit 728b. The second voltage detection circuit 728b may be coupled to a fourth port 746d of the directional coupler 726. The power/impedance detector 724 may measure 808 a third voltage V3rms 754c using a third voltage detection circuit 728c. The third voltage detection circuit 728c may be coupled to a second port 746b of the directional coupler 726.

The power/impedance detector 724 may measure 810 a fourth voltage V4rms 754d using a fourth voltage detection circuit 728d. The fourth voltage detection circuit 728d may be coupled between the first impedance Z1j 730 and the second impedance Z2j 732. In one example, the first impedance Z1j 730 may include a capacitor in series between the second port 746b and the second impedance Z2j 732.

The power/impedance detector 724 may measure 812 a fifth voltage V5rms 754e using a fifth voltage detection circuit 728e. The fifth voltage detection circuit 728e may be coupled between the second Z2j impedance 732 and the load impedance Zload 718. In one example, the second impedance Z2j 732 may include a capacitor in series between the first impedance Z1j 730 and the load impedance Zload 718. In some configurations, the impedance values of the first impedance Z1j 730 and the second impedance Z2j 732 may be approximately equal.

The power/impedance detector 724 may determine 814 a delivered power TRP estimate 134 using V1rms 754a, V2rms 754b, V3rms 754c, V4rms 754d and V5rms 754e. The power/impedance detector 724 may also determine 816 a load impedance Zload estimate 136 using V1rms 754a, V2rms 754b, V3rms 754c, V4rms 754d and V5rms 754e. In determining the delivered power TRP estimate 134 and the load impedance Zload estimate 136, various approaches and calculations may be used, including those discussed above in relation to FIGS. 3, 5 and 7.

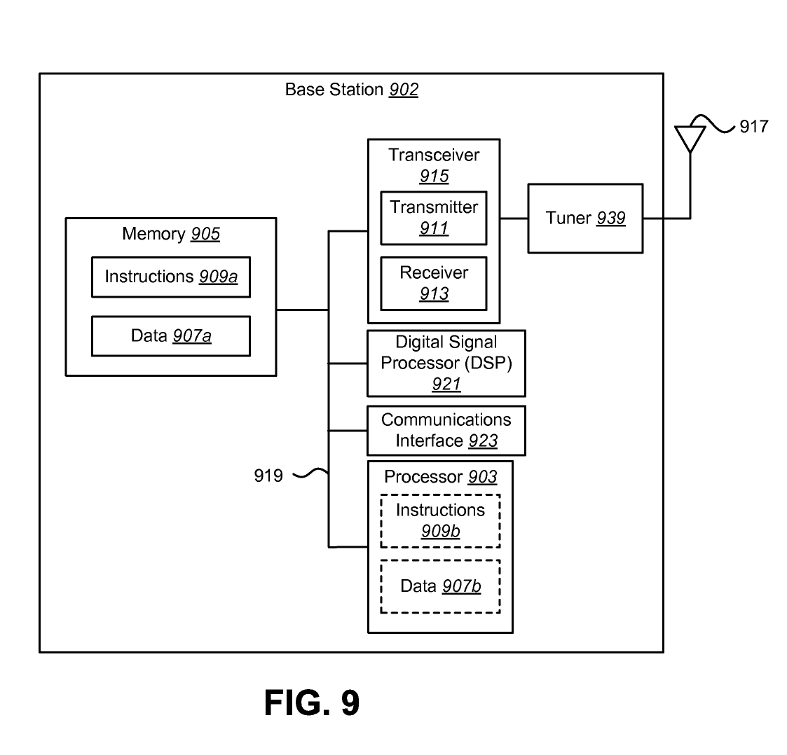

FIG. 9 illustrates certain components that may be included within a base station 902 according to some embodiments of the present invention. A base station 902 may also be referred to as, and may include some or all of the functionality of, an access point, a broadcast transmitter, a NodeB, an evolved NodeB, etc.

The base station 902 includes a processor 903. The processor 903 may be a general purpose single- or multi-chip microprocessor (e.g., an ARM), a special purpose microprocessor (e.g., a digital signal processor (DSP)), a microcontroller, a programmable gate array, etc. The processor 903 may be referred to as a central processing unit (CPU). Although just a single processor 903 is shown in the base station 902 of FIG. 9, in an alternative configuration, a combination of processors (e.g., an ARM and DSP) could be used.

The base station 902 also includes memory 905. The memory 905 may be any electronic component capable of storing electronic information. The memory 905 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 907a and instructions 909a may be stored in the memory 905. The instructions 909a may be executable by the processor 903 to implement the methods disclosed herein. Executing the instructions 909a may involve the use of the data 907a that is stored in the memory 905. When the processor 903 executes the instructions 909a, various portions of the instructions 909b may be loaded onto the processor 903, and various pieces of data 907b may be loaded onto the processor 903.

The base station 902 may also include a transmitter 911 and a receiver 913 to allow transmission and reception of signals to and from the base station 902. The transmitter 911 and receiver 913 may be collectively referred to as a transceiver 915. An antenna 917 may be electrically coupled to the transceiver 915. A tuner 939 may be coupled between the transceiver 915 and the antenna 917. The base station 902 may also include (not shown) multiple transmitters, multiple receivers, multiple transceivers and/or additional antennas.

The base station 902 may include a digital signal processor (DSP) 921. The base station 902 may also include a communications interface 923. The communications interface 923 may allow a user to interact with the base station 902.

The various components of the base station 902 may be coupled together by one or more buses, which may include a power bus, a control signal bus, a status signal bus, a data bus, etc. For the sake of clarity, the various buses are illustrated in FIG. 9 as a bus system 919.

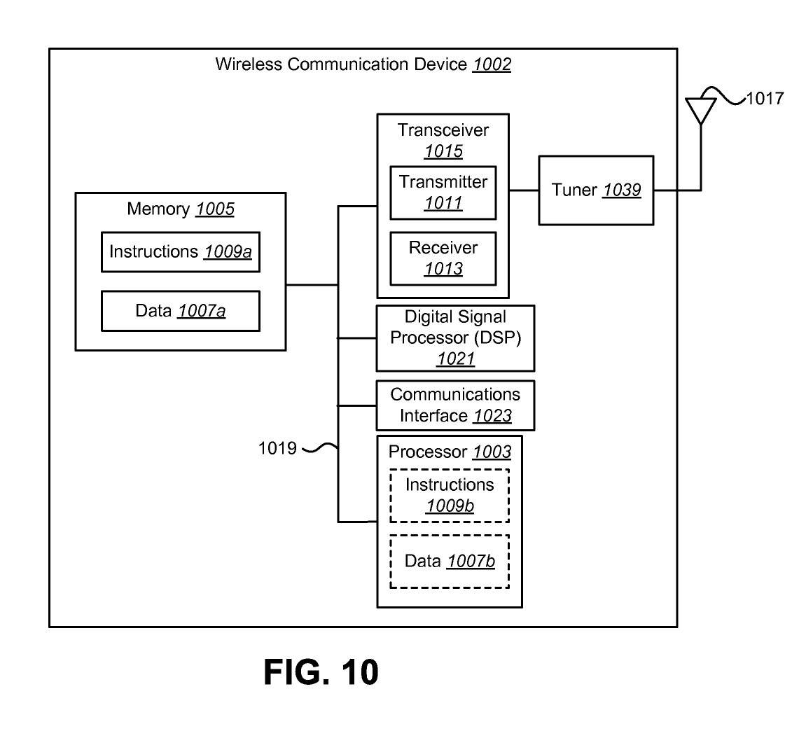

FIG. 10 illustrates certain components that may be included within a wireless communication device 1002 according to some embodiments of the present invention. The wireless communication device 1002 may be an access terminal, a mobile station, a user equipment (UE), etc. The wireless communication device 1002 includes a processor 1003. For example the wireless communication device 1002 may be the wireless device of FIG. 1.

The processor 1003 may be a general purpose single- or multi-chip microprocessor (e.g., an ARM), a special purpose microprocessor (e.g., a digital signal processor (DSP)), a microcontroller, a programmable gate array, etc. The processor 1003 may be referred to as a central processing unit (CPU). Although just a single processor 1003 is shown in the wireless communication device 1002 of FIG. 10, in an alternative configuration, a combination of processors (e.g., an ARM and DSP) could be used.

The wireless communication device 1002 also includes memory 1005. The memory 1005 may be any electronic component capable of storing electronic information. The memory 1005 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 1007a and instructions 1009a may be stored in the memory 1005. The instructions 1009a may be executable by the processor 1003 to implement the methods disclosed herein. Executing the instructions 1009a may involve the use of the data 1007a that is stored in the memory 1005. When the processor 1003 executes the instructions 1009, various portions of the instructions 1009b may be loaded onto the processor 1003, and various pieces of data 1007b may be loaded onto the processor 1003.

The wireless communication device 1002 may also include a transmitter 1011 and a receiver 1013 to allow transmission and reception of signals to and from the wireless communication device 1002 via an antenna 1017. The transmitter 1011 and receiver 1013 may be collectively referred to as a transceiver 1015. A tuner 1039 may be coupled between the transceiver and the antenna 1017. The wireless communication device 1002 may also include (not shown) multiple transmitters, multiple antennas, multiple receivers and/or multiple transceivers.

The wireless communication device 1002 may include a digital signal processor (DSP) 1021. The wireless communication device 1002 may also include a communications interface 1023. The communications interface 1023 may allow a user to interact with the wireless communication device 1002.

The various components of the wireless communication device 1002 may be coupled together by one or more buses, which may include a power bus, a control signal bus, a status signal bus, a data bus, etc. For the sake of clarity, the various buses are illustrated in FIG. 10 as a bus system 1019.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any non-transitory tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein include one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 2, 4, 6 and 8, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

We claim:

1. A wireless device configured for optimizing a delivered power, comprising:
a filter duplexer or switch coupled to a transmitter and a receiver;
a power/impedance detector coupled to the filter duplexer or switch, wherein the power/impedance detector comprises a directional coupler; and
an antenna coupled to the power/impedance detector.

2. The wireless device of claim 1, wherein the power/impedance detector further comprises a plurality of voltage detection circuits, wherein the plurality of voltage detection circuits measure a plurality of voltages within the power/impedance detector.

3. The wireless device of claim 2, wherein the plurality of voltage detection circuits are root means squared voltage detection circuits.

4. The wireless device of claim 2, wherein the power/impedance detector is configured to:
determine a delivered power estimate based on the plurality of voltages; and
determine a load impedance estimate based on the plurality of voltages.

5. The wireless device of claim 1, further comprising a tuner control coupled to the power/impedance detector, wherein the power/impedance detector provides a delivered power estimate and a load impedance estimate to the tuner control.

6. The wireless device of claim 5, wherein the tuner control is configured to determine tuning parameters for an impedance matching circuit based on the delivered power estimate and the load impedance estimate.

7. The wireless device of claim 6, wherein the tuner control applies the tuning parameters to the impedance matching circuit to optimize the delivered power.

8. The wireless device of claim 1, wherein the power/impedance detector further comprises a first voltage detection circuit, a second voltage detection circuit, a third voltage detection circuit and a fourth voltage detection circuit, wherein voltage detection circuits measure a plurality of voltages within the power/impedance detector, and wherein the directional coupler comprises a first port, a second port, a third port and a fourth port.

9. The wireless device of claim 8, wherein the first voltage detection circuit is coupled to the third port, wherein the second voltage detection circuit is coupled to the fourth port, wherein the third voltage detection circuit is coupled to the second port, and wherein the fourth voltage detection circuit is coupled to the first port.

10. The wireless device of claim 8, further comprising a first impedance coupled between the second port and the antenna, wherein the first voltage detection circuit is coupled to the third port, wherein the second voltage detection circuit is coupled to the fourth port, wherein the third voltage detection circuit is coupled to the second port, and wherein the fourth voltage detection circuit is coupled between the first impedance and the antenna.

11. The wireless device of claim 8, further comprising:
a fifth voltage detection circuit;
a first impedance coupled to the second port; and
a second impedance coupled between the first impedance and the antenna, wherein the first voltage detection circuit is coupled to the third port, wherein the second voltage detection circuit is coupled to the fourth port, wherein the third voltage detection circuit is coupled to the second port, wherein the fourth voltage detection circuit is coupled between the first impedance and the second impedance, and wherein the fifth voltage detection circuit is coupled between the second impedance and the antenna.

12. The wireless device of claim 1, wherein the power/impedance detector is configured to:
monitor a plurality of voltages;
determine a delivered power estimate based on the plurality of voltages within time intervals; and
determine a load impedance estimate based on the plurality of voltages within time intervals.

13. A method for optimizing a delivered power in a wireless device, comprising:
measuring a voltage of a plurality of points within a power/impedance detector, wherein the power/impedance detector comprises a directional coupler;
determining a delivered power estimate;
determining a load impedance estimate; and
optimizing the delivered power based on the delivered power estimate and the load impedance estimate.

14. The method of claim 13, wherein the delivered power estimate and the load impedance estimate are based on the measured voltages.

15. The method of claim 13, further comprising:
providing the delivered power estimate to a tuner control;
providing the load impedance estimate to the tuner control; and
determining tuning parameters based on the delivered power estimate and the load impedance estimate.

16. The method of claim 15, further comprising adjusting an impedance matching circuit using the tuning parameters.

17. The method of claim 13, wherein the method is performed by a wireless device comprising:
a filter duplexer or switch coupled to a transmitter and a receiver;
a power/impedance detector coupled to the filter duplexer or switch, wherein the power/impedance detector comprises a directional coupler; and
an antenna coupled to the power/impedance detector.

18. The method of claim 17, wherein the power/impedance detector further comprises a plurality of voltage detection circuits, wherein the plurality of voltage detection circuits measure a plurality of voltages within the power/impedance detector.

19. The method of claim 18, wherein the plurality of voltage detection circuits are root means squared voltage detection circuits.

20. The method of claim 18, wherein the power/impedance detector is configured to:
determine the delivered power estimate based on the plurality of voltages; and
determine the load impedance estimate based on the plurality of voltages.

21. The method of claim 17, further comprising a tuner control coupled to the power/impedance detector, wherein the power/impedance detector provides the delivered power estimate and the load impedance estimate to the tuner control.

22. The method of claim 21, wherein the tuner control is configured to determine tuning parameters for an impedance matching circuit based on the delivered power estimate and the load impedance estimate.

23. The method of claim 22, wherein the tuner control applies the tuning parameters to the impedance matching circuit to optimize the delivered power.

24. The method of claim 17, wherein the power/impedance detector further comprises a first voltage detection circuit, a second voltage detection circuit, a third voltage detection circuit and a fourth voltage detection circuit, wherein voltage detection circuits measure a plurality of voltages within the power/impedance detector, and wherein the directional coupler comprises a first port, a second port, a third port and a fourth port.

25. The method of claim 24, further comprising:
measuring a first voltage using the first voltage detection circuit, wherein the first voltage detection circuit is coupled to the third port;
measuring a second voltage using the second voltage detection circuit, wherein the second voltage detection circuit is coupled to the fourth port;
measuring a third voltage using the third voltage detection circuit, wherein the third voltage detection circuit coupled to the second port;
measuring a fourth voltage using the fourth voltage detection circuit, wherein the fourth voltage detection circuit coupled to the first port; and
determining the delivered power estimate and the load impedance estimate using the first voltage, second voltage, third voltage and fourth voltage.

26. The method of claim 24, further comprising:
measuring a first voltage using the first voltage detection circuit, wherein the first voltage detection circuit is coupled to the third port;
measuring a second voltage using the second voltage detection circuit, wherein the second voltage detection circuit is coupled to the fourth port;
measuring a third voltage using the third voltage detection circuit, wherein the third voltage detection circuit is coupled to the second port;
measuring a fourth voltage using the fourth voltage detection circuit, wherein the fourth voltage detection circuit is coupled between a first impedance and the antenna, and wherein the first impedance is coupled between the second port and the antenna; and
determining the delivered power estimate and the load impedance estimate using the first voltage, second voltage, third voltage and fourth voltage.

27. The method of claim 24, further comprising:
measuring a first voltage using the first voltage detection circuit, wherein the first voltage detection circuit is coupled to the third port;
measuring a second voltage using the second voltage detection circuit, wherein the second voltage detection circuit is coupled to the fourth port;
measuring a third voltage using the third voltage detection circuit, wherein the third voltage detection circuit is coupled to the second port;
measuring a fourth voltage using the fourth voltage detection circuit, wherein the fourth voltage detection circuit is coupled between a first impedance and a second impedance, wherein the first impedance is coupled to the second port, and wherein the second impedance is coupled between the first impedance and the antenna;
measuring a fifth voltage using a fifth voltage detection circuit, wherein the fifth voltage detection circuit is coupled between the second impedance and the antenna; and
determining the delivered power estimate and the load impedance estimate using the first voltage, second voltage, third voltage, fourth voltage and fifth voltage.

28. The method of claim 13, further comprising:
monitoring a plurality of voltages;
determining at the delivered power estimate based on the plurality of voltages within time intervals; and
determining the load impedance estimate based on the plurality of voltages within time intervals.

29. A computer-program product for optimizing a delivered power in a wireless device, the computer-program product comprising a non-transitory computer-readable medium having instructions thereon, the instructions comprising:
code for causing the wireless device to measure a voltage of a plurality of points within a power/impedance detector, wherein the power/impedance detector comprises a directional coupler;
code for causing the wireless device to determine a delivered power estimate;
code for causing the wireless device to determine a load impedance estimate; and
code for causing the wireless device to optimize the delivered power based on the delivered power estimate and the load impedance estimate.

30. The computer-program product of claim 29, wherein the delivered power estimate and the load impedance estimate are based on the measured voltages.

31. The computer-program product of claim 29, the instructions further comprising:
code for causing the wireless device to provide the delivered power estimate to a tuner control;
code for causing the wireless device to provide the load impedance estimate to the tuner control; and
code for causing the wireless device to determine tuning parameters based on the delivered power estimate and the load impedance estimate.
